(19) United States
(12) Patent Application Publication
(10) Pub. No.: US 2003/0130036 A1
(43) Pub. Date: Jul. 10, 2003

(54) Handheld joystick type or monitor device on the wheel

(75) Inventor: Kent T.J. Hsu, Taipei (TW)

Correspondence Address: BACON & THOMAS, PLLC, 625 SLATERS LANE, FOURTH FLOOR, ALEXANDRIA, VA, 22314

(73) Assignee: Asoka Inc., Taipei (TW)

(21) Appl. No.: 10/035,128

(22) Filed: Jan. 4, 2002

(51) Int. Cl. A63F 13/00

(52) U.S. Cl. 463/36; 463/37; 463/39; 463/38; 463/47

(57) ABSTRACT

This invention is a kind of “HANDHELD JOYSTICK TYPE OR MONITOR DEVICE ON THE WHEEL”, in particular, means by using the LCD monitor installed and fixed on the handheld joystick or the wheel of the video game, so the player can just carry the main body and software of the video game to play anytime and anyplace, while he won't have to sit in front of TV screen to play with video game, this will increase its convenience and entertainment.

### BACKGROUND OF THE INVENTION

1. Field of the Invention

It is an LCD monitor on top of the joystick for the player to easily view and play anytime and anyplace.

2. Description of the Related Art

The existing video game (A) includes a main body (A1) and a handheld joystick (A2), by connecting TV screen (A3) with AV connector (A4), as seen in FIG. 5, we can use the main body (A1) to drive the software and display the animation on TV screen (A3) and then use the handheld joystick (A2) on the main body (A1) to view at TV screen (A3), while operating the handheld joystick (A2) at the same time, and allows the player to exercise flexibly with his hands and mind; however, this type of design will restrict the player to sit dully in front of TV screen (A3) to play with the video game (A), which will easily make the player to take over TV screen (A3) solely, and he will be playing at the same place with the same position from beginning to end, this will not only cause inconvenience for the family who wish to watch other TV program at the same time, it also restricts the player to play only at a place with a TV, this will become a part of consideration for the consumers before they decide to purchase.

### SUMMARY OF THE INVENTION

The main purpose of this invention is to use the LCD monitor that can be fixed on the handheld joystick or the wheel of the video game to enable the player to directly view at the LCD monitor above the handheld joystick to have fun anytime and anyplace.

In addition, this LCD monitor invention can also be fixed in the center of the wheel of the video game and have fun anytime and anyplace, this is another purpose of this invention.

Furthermore, the LCD monitor on the handheld joystick not only can be connected to the main body through the connector, we can also use the AV terminal on the LCD monitor to connect with a Turner to become a TV, or to connect with a V8 lens to become a V8 video camera as a multiple functions product, this is another purpose of this invention.

### BRIEF DESCRIPTION OF THE DRAWINGS

FIG. 1—The implemental sketch drawing of this invention device.

FIG. 2—Side view drawing of this invention device.

FIG. 3—Another implemental sketch drawing of this invention device by fixing onto the wheel of the video game.

FIG. 4—Square block drawing of this invention device.

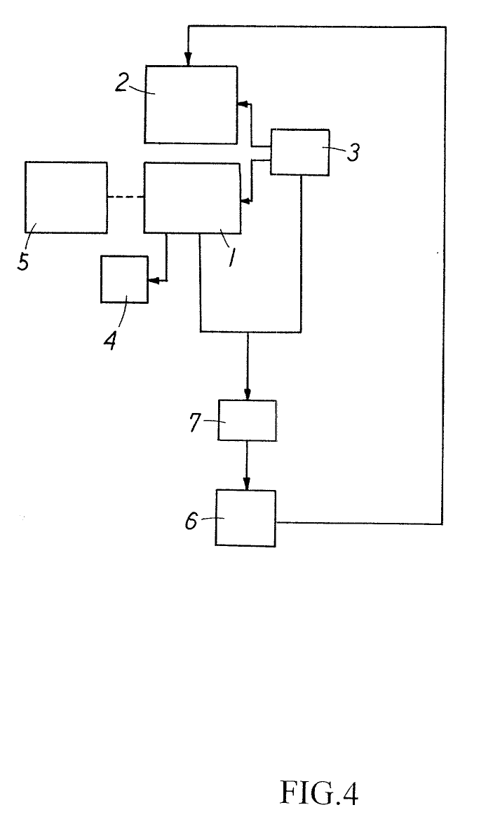

FIG. 5—The typical sketch drawing of the existing video game.

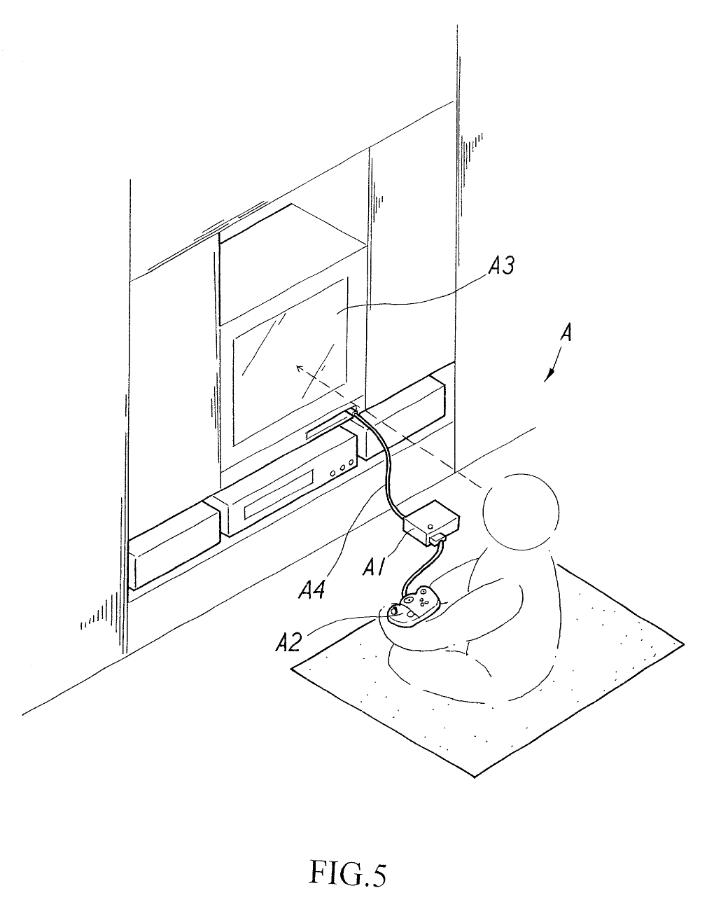

### DETAILED DESCRIPTION OF THE PREFERRED EMBODIMENT

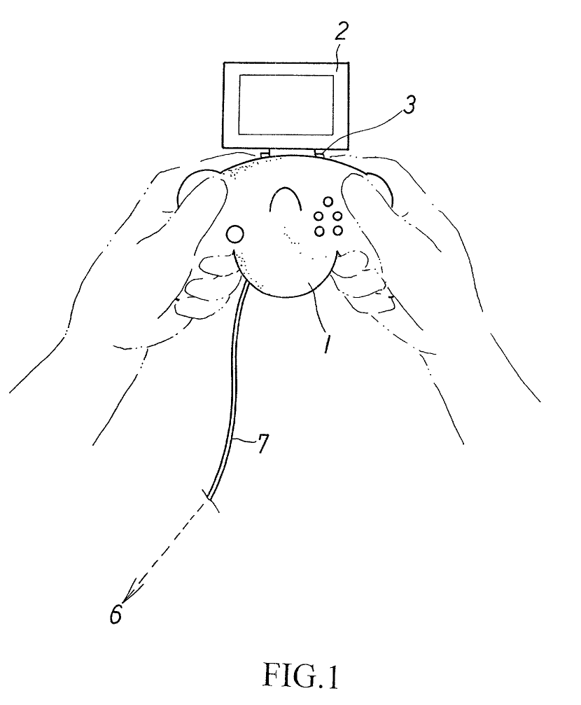

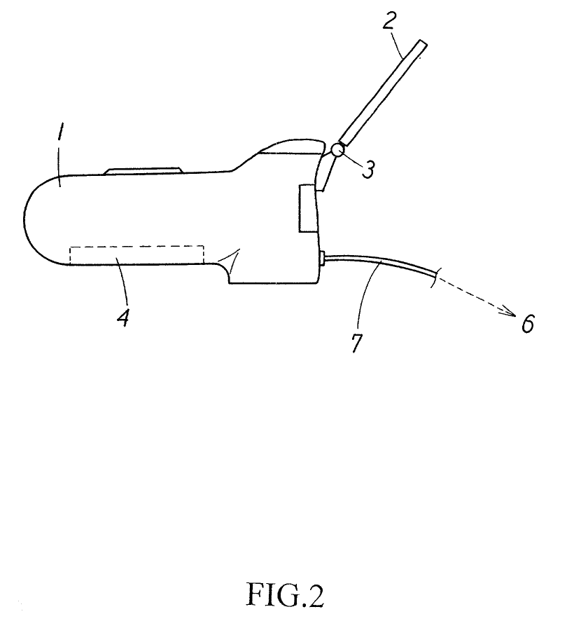

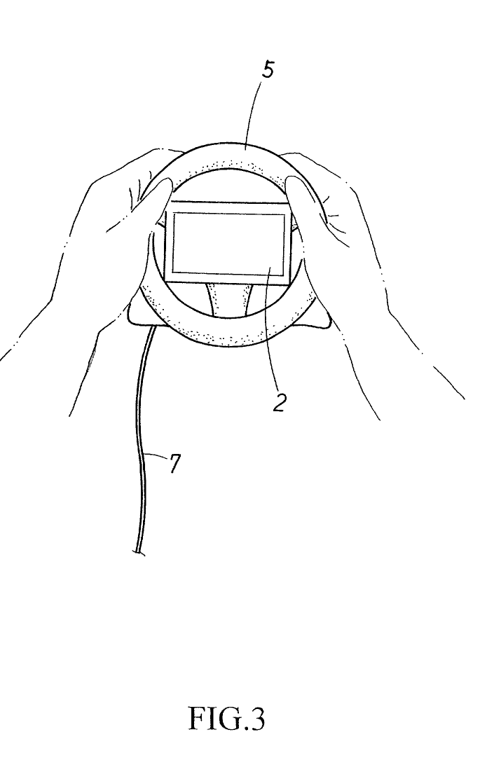

Please refer to FIG. 1, FIG. 2 and FIG. 3 first, the LCD monitor (2) can be fixed in front of the handheld joystick (1) by using one side of its fixture (3) to connect the base of the handheld joystick (1), and using the other side to connect the back of the LCD monitor (2);

When the LCD monitor is installed onto the handheld joystick (1), the fixture (3) can be used to fix the LCD monitor (2) with one side fixed to the handheld joystick (1) and one side fixed to the LCD monitor (2), and connect the main body (6) through a connector (7), so the player can carry the main body (6) and software to play anytime and anyplace, and he doesn't have to sit in front of TV screen (A3) to play with video game (A), this will increase its convenience and entertainment, and enable the player to play anyplace than just playing at the same place with the same position from beginning to end which not only causes inconvenience for the family who wish to watch other TV program at the same time, it also restricts the player to play only at a place with a TV.

The power source of this invention handheld joystick (1) comes from its battery chamber (4) and not restrict to the battery chamber (4) only, we can use a power cord to get directly the power from home, from the joystick socket, or from mobile charging in the car, etc.

Furthermore, this invention can also connect the AV terminal on the LCD monitor (2) with a Tuner to become a TV, or to connect with the AV terminal of the V8 lens to become a V8 video camera, so to watch VCD, DVD video or listen to MP3 music, etc., and make this invention as a product for the young and old.

In addition, please refer to FIG. 3 that shows the invention LCD monitor (2) can also be fixed onto the wheel (5) for the player to play anytime and anyplace.

Concluded from the above, this invention is to use the LCD monitor that can be fixed on the handheld joystick or the wheel of the video game to enable the player to carry the video game main body and software to play anytime and anyplace, which indeed increases its additional usage value and fulfill the needed elements for applying new design patent of “Innovation”, “Practical” and “Progressing”, therefore, we hereby prepare the documents and file in the patent application according to the law, and sincerely hope to receive early your esteemed Bureau's approval on this case.

What is claimed is:

1. A “HANDHELD JOYSTICK TYPE OR MONITOR DEVICE ON THE WHEEL” includes:
The LCD monitor is installed in front of the handheld joystick of the video game (include the battery chamber), using one side of the fixture to connect with the base of the handheld joystick, and the other side connect with the back of the LCD monitor, through a connector to the main body, can create the pleasure of playing anytime and anyplace.

2. As described in the first patent coverage range “HANDHELD JOYSTICK TYPE OR MONITOR DEVICE ON THE WHEEL”, the power source of the described handheld joystick comes from its battery chamber, it can also use a power cord to get directly the power from home, from the joystick socket, or from mobile charging in the car, etc.
